(19) United States
(12) Patent Application Publication
(10) Pub. No.: US 2025/0386184 A1
(43) Pub. Date: Dec. 18, 2025

(54) SYSTEM AND METHOD TO SELECT MULTI-RADIO ACCESS TECHNOLOGY IN A USER EQUIPMENT DURING SIM INITIALIZATION

(71) Applicant: JIO PLATFORMS LIMITED, Ahmedabad (IN)

(72) Inventors: Ranjit Ma KUMAR, Jabalpur (IN); Anil Kumar PATIL, Kalyan East, (IN); Sonender KUMAR, Etawah (IN); Abhishek BHASKAR, Ranchi (IN); Jaswant SINGH, Jodhpur (IN)

(73) Assignee: JIO PLATFORMS LIMITED, Ahmedabad (IN)

(21) Appl. No.: 18/880,028

(22) PCT Filed: Jun. 30, 2023
(86) PCT No.: PCT/IB2023/056830

§ 371 Date: Dec. 30, 2024

(30) Foreign Application Priority Data
Jun. 30, 2022 (IN) 202221037831

(51) Int. Cl. H04W 8/26; H04W 8/22; H04W 60/04; H04W 84/04

(52) U.S. Cl. CPC H04W 8/265; H04W 8/22; H04W 60/04; H04W 84/042

(57) ABSTRACT

The present disclosure relates to a system and a method for selecting multi-radio access technology (RAT) in a user equipment (UE) during an initialization of subscriber identity module (SIM). The method includes reading capability information associated with the UE from a universal integrated circuit card (UICC) at the time of initializing the SIM, determining whether the UE includes a capability to connect to a first network having a first RAT based on the capability information, and registering the UE with the first network having the first RAT based on the UE capable of being connected to the first network.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure relates to multiple radio access technology (RAT) network selection, and more particularly, to a system and a method to select a multi-RAT network in a user equipment (UE) during subscriber identity module (SIM) initialization.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In today's world majority of mobile phone users migrated to fourth generation (4G) long-term evolution (LTE) network and use 4G profile subscriber identity module (SIM) card. With emerging technological advancement in mobile communication, many original equipment manufacturers (OEM)/original device manufacturers (ODM) have come up with user equipments with 5G capabilities even before the 4G networks are completely upgraded to 5G network or the launch of 5G new radio (NR). The UEs with 5G capability, however, use the existing 4G SIM cards. Traditional 4G SIM cards do not contain the 5G profiles/files required for the registration with a 5G network. However, 5G capable UE include 5G global/auto mode selected in network settings and therefore try to start registering with a 5G network when encountered. In such cases, the UE registration fails with the network due to pre-decided reject as subscription is not available for these traditional 4G SIM international mobile subscriber identity (IMSI). This situation leads to unnecessary overhead registration signaling, resulting in the degradation of the network key performance indicators (KPIs). Other drawbacks include a delay in the time taken by the UE to register with the 4G network due to unnecessary registration tries on the 5G, a 5G registration loop as the UE may get into a loop of 5G registration request and reject and may require rebooting to register with 4G, and reduced battery efficiency at the UE due to extra signalling.

Further, for every rejection from the network, the UE does the IMSI attach instead of using a globally unique temporary identifier (GUTI) which is not desirable for security reasons.

There is, therefore, a need in the art to provide a system and a method that can overcome the shortcomings of the existing prior arts.

### SUMMARY

This section is provided to introduce certain objects and aspects of the present disclosure in a simplified form that are further described below in the detailed description. This summary is not intended to identify the key features or the scope of the claimed subject matter.

In one aspect, the present disclosure relates to a system for selecting a radio access technology (RAT) during an initialization of a subscriber identity module (SIM) in a user equipment (UE). The system includes one or more processors and a memory operatively coupled to the one or more processors, wherein the memory includes processor-executable instructions, which on execution, cause the one or more processors to read capability information associated with the UE from a universal integrated circuit card (UICC) during the initialization of the SIM, determine whether the UE includes a capability to connect to a first network having a first RAT based on the capability information, and register the UE with the first network having the first RAT based on the UE including the capability to connect to the first network.

In some embodiments, the one or more processors may be configured to register the UE with a second network having a second RAT based on the UE not being capable to connect to the first network.

In some embodiments, the one or more processors may be configured to deactivate one or more device capabilities associated with the UE to connect to the first network and register the UE with the second network.

In some embodiments, the capability information may include at least one of service capability information associated with the UE or a pre-defined public land mobile network (PLMN) list, wherein the service capability information may include one or more service subscriptions associated with the first network and the pre-defined PLMN list may include one or more PLMNs, a RAT associated with the one or more PLMNs, a priority associated with the one or more PLMNs, and a subscription information associated with the one or more PLMNs.

In some embodiments, the one or more processors may be configured to determine whether a service identifier associated with the one or more service subscriptions in the first network is present in the service capability information and register with the first network based on the presence of the service identifier in the service capability information.

In some embodiments, the one or more processors may be configured to determine whether a subscription to the first network is enabled based on the subscription information in the PLMN list and register with the first network based on the subscription to the first network being enabled in the subscription information.

In another aspect, the present disclosure relates to a method for selecting a RAT during an initialization of a SIM in a UE. The method includes reading, by one or more processors, capability information associated with the UE from a UICC during the initialization of the SIM, determining, by the one or more processors, whether the UE includes a capability to connect to a first network having a first RAT based on the capability information, and registering, by the one or more processors, the UE with the first network having the first RAT based on the UE including the capability to connect to the first network.

In some embodiments, the method may include registering, by the one or more processors, the UE with a second network having a second RAT based on the UE not being capable to connect to the first network.

In some embodiments, the method may include deactivating, by the one or more processors, one or more device capabilities associated with the UE to connect to the first network and registering, by the one or more processors, the UE with the second network.

In some embodiments, the method may include determining, by the one or more processors, whether a service identifier associated with the one or more service subscriptions in the first network is present in the service capability information and registering, by the one or more processors, with the first network based on the presence of the service identifier in the service capability information.

In some embodiments, the method may include determining, by the one or more processors, whether a subscription to the first network is enabled based on the subscription information in the PLMN list and registering, by the one or more processors, with the first network based on the subscription to the first network being enabled in the subscription information.

In one another aspect, the present disclosure relates to a UE. The UE includes a SIM card and one or more processors communicatively coupled to a system and operatively coupled to a memory including processor-executable instructions, which on execution, cause the one or more processors to read capability information associated with the UE from a UICC during the initialization of the SIM card, determine whether the UE includes a capability to connect to a first network having a first RAT based on the capability information and register the UE with the first network having the first RAT based on the UE including the capability to connect to the first network.

In yet another aspect, the present disclosure relates to a non-transitory computer readable medium that includes one or more instructions stored thereupon that when executed by a processor causes the processor to read capability information associated with a UE from a UICC during an initialization of a SIM card, determine whether the UE includes a capability to connect to a first network having a first RAT based on the capability information, and register the UE with the first network having the first RAT based on the UE including the capability to connect to the first network.

### OBJECTS OF THE PRESENT DISCLOSURE

Some of the objects of the present disclosure, which at least one embodiment herein satisfies are as listed herein below.

It is an object of the present disclosure to provide a user equipment (UE) with pre-requisites to either attach on 4G network directly or attempt to register on 5G/6G network based on subscriber identity module (SIM) profile information during initialization.

It is another object of the present disclosure to provide a mechanism to reduce the unnecessary signalling overhead in a communication network.

It is yet another object of the present disclosure to enhance the battery life of the UE trying to register with the communication network.

It is yet another object of the present disclosure to provide quick attach/registration of the UE with the communication network.

It is yet another object of the present disclosure to determine the camping radio access technology (RAT) at the first stage of SIM initialization by reading the SIM card profile and determining if the profile contains 4G/5G/6G elementary files.

It is yet another object of the present disclosure to update the elementary files related to 5G/6G on the SIM card for users who have subscribed to the 5G/6G services.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary representation of a network architecture (100) for selecting a radio access technology (RAT) during subscriber identity module (SIM) initialization, in accordance with an embodiment of the present disclosure.

FIG. 2 illustrates an exemplary block diagram (200) of the proposed system for selecting a RAT during SIM initialization, in accordance with an embodiment of the present disclosure.

FIG. 3 illustrates an exemplary flow chart of a method (300) for selecting a RAT during SIM initialization, in accordance with an embodiment of the present disclosure.

FIG. 4A illustrates a universal subscriber identity module (USIM) table with service identifiers, in accordance with an embodiment of the present disclosure.

FIG. 4B illustrates an elementary file associated with public land mobile network (EFPLMN), in accordance with an embodiment of the present disclosure.

FIG. 4C illustrates a byte format associated with the EFPLMN, in accordance with an embodiment of the present disclosure.

FIG. 5 illustrates an exemplary computer system (500) in which or with which embodiments of the present disclosure may be implemented.

The foregoing shall be more apparent from the following more detailed description of the invention.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Certain terms and phrases have been used throughout the disclosure and will have the following meanings in the context of the ongoing disclosure.

The term “RAT” may refer to radio access technology i.e., the various connection technologies used in a communication network, for example, without limitations, 2G/3G/4G/5G/6G.

The term “SIM” may refer to subscriber identity module, used for identifying and authenticating subscribers on mobile telephony devices. SIM is an integrated circuit (IC) to securely store the international mobile subscriber identity (IMSI) number and its related key.

The term “UICC” may refer to universal integrated circuit card. UICC implements a smart card technology and has its own processor, software, and data storage. It may enable secure network access with 5G network.

The term “USST” may refer to universal SIM service table comprising one or more network profiles that are supported by the SIM.

The present disclosure provides a robust and effective solution for selecting a radio access technology (RAT) during SIM initialization. In an aspect, the present disclosure provides reading capability information associated with a user equipment (UE) from a universal integrated circuit card (UICC) during the initialization of the SIM and decide to register the UE with a first network using a first RAT or a second network using a second RAT based on the capability information. The capability information may include a list of network technologies for which the UE has subscription and may be stored in a USST. During power on and SIM initialization, the UE may scan/read the information from the UICC and decide to disable or enable a NI mode or a dual connectivity on new radio (DCNR) mode based on the read information. In one embodiment, the UE may enable the NI/DCNR mode if a service capability information, for example, without limitations, an identifier “6F38” is present in the USST. In some embodiments, the UE may enable the NI/DCNR mode based on a bit field in an elementary file (EF), for example, if bit B4 in an elementary file EF 6F60 is enabled, the UE may enable the NI/DCNR mode. On the other hand, the UE may directly register with a 4G network.

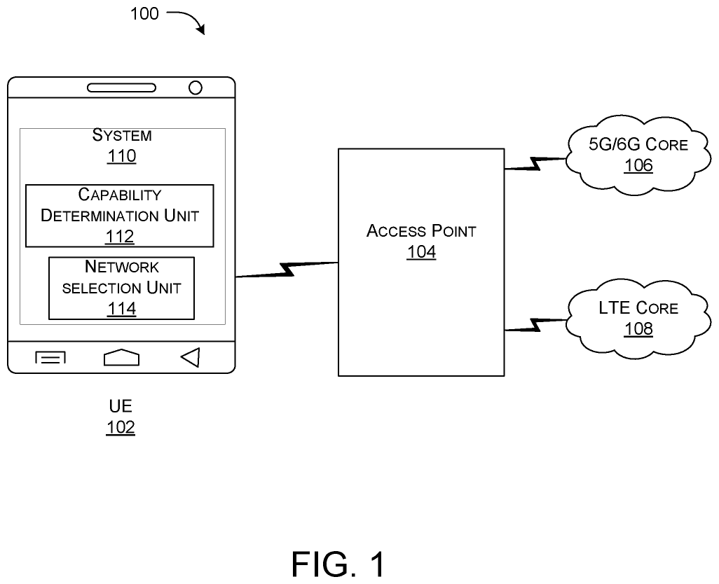

The various embodiments throughout the disclosure will be explained in more detail with reference to FIGS. 1-5.

FIG. 1 illustrates an exemplary representation of a network architecture (100) for selecting a radio access technology (RAT) during subscriber identity module (SIM) initialization, in accordance with an embodiment of the present disclosure.

Referring to FIG. 1, the network (100) may include a UE (102) communicating with a 5G/6G core (106) or a 4G or long-term evolution (LTE) core (108), through an access point (AP) (104). The UE (102) may be implemented as a system (110) for enabling selection of at least one of the 5G core/6G (106) or 4G core (108) during initialization of a SIM in the UE (104).

In an embodiment, the UE (102) may include, but are not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of UE (102) with wireless communication capabilities, and the like. In an embodiment, the UE (102) may include, but are not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the UE (102) may include one or more in-built or externally coupled accessories including, but not limited to, a visual aid device such as camera, audio aid, a microphone, a keyboard, and input devices for receiving input from a user such as touch pad, touch enabled screen, electronic pen, and the like.

In an embodiment, the UE (102) may include smart devices operating in a smart environment. In such an embodiment, the UE (102) may include, but are not limited to, smart phones, smart watches, smart sensors (e.g., mechanical, thermal, electrical, magnetic, etc.), networked appliances, networked peripheral devices, networked lighting system, communication devices, networked vehicle accessories, smart accessories, tablets, smart television (TV), computers, smart security system, smart home system, other devices for monitoring or interacting with or for users and/or places, or any combination thereof. In an embodiment, the user equipment (102) may include one or more of the following components: sensor, radio frequency identification (RFID) technology, GPS technology, mechanisms for real-time acquisition of data, passive or interactive interface, mechanisms of outputting and/or inputting sound, light, heat, electricity, mechanical force, chemical presence, biological presence, location, time, identity, other information, or any combination thereof.

A person of ordinary skill in the art will appreciate that the UE (102) may not be restricted to the mentioned devices and various other devices may be used.

In an embodiment, the UE (102) may connect to one of the 5G/6G core (106) or the LTE core (108) through an access point (104). In some embodiments, the access point (104) may include an evolved node B (eNB) or a gnode B (gNB).

A person of ordinary skill in the art will appreciate that the 5G/6G core (106) and the LTE core (108) may not be restricted to the mentioned network but may include any two different networks using different radio access technologies (RATs).

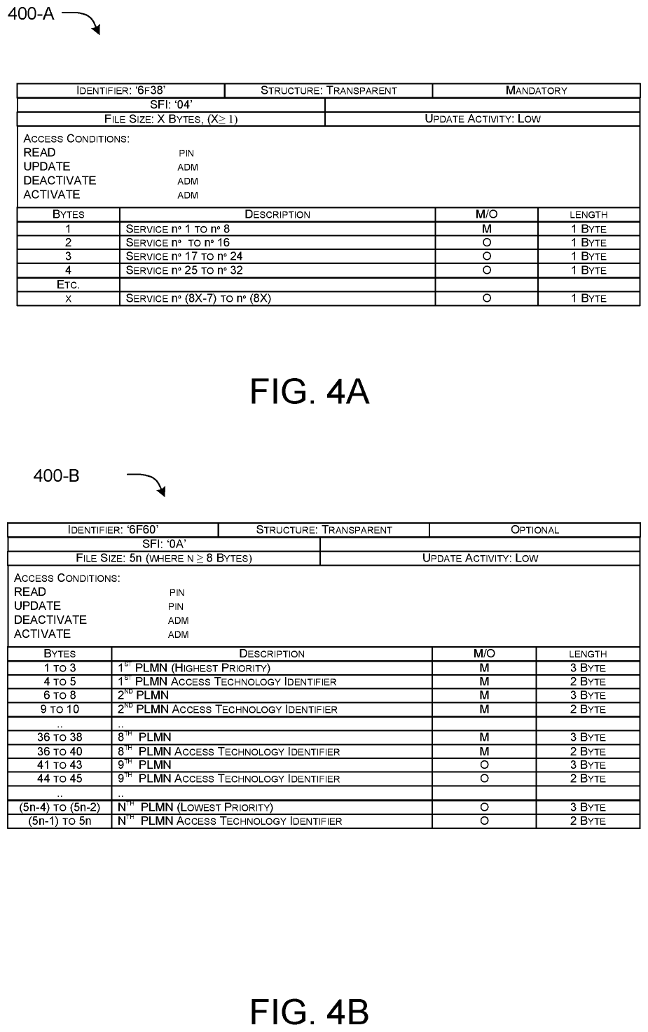

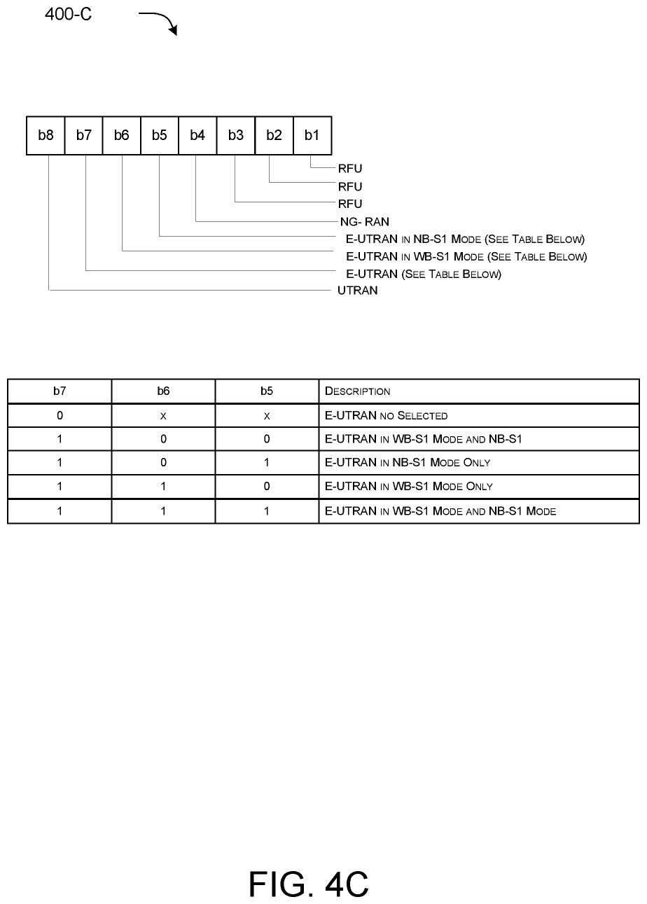

Referring to FIG. 1, the UE (102) or the system (110) may include a capability determination unit (112) and a network selection unit (114). The capability determination unit (112) may determine whether the UE (102) includes capability to register with the 5G/6G core network (106) based on capability information. The network selection unit (114) may enable selecting either the first network (106) or the second network (108) by the UE (102) based on the capability information from the capability determination unit (112). The capability information may include information related to whether a user is subscribed for registering with 5G/6G core network (106). The capability information may be stored in a UICC associated with the UE (102). The capability information may be obtained based on one or more identifiers specified in a USST or a public land mobile network (PLMN) elementary file (EFPLMN), as shown in FIGS. 4A and 4B, respectively, and discussed below.

In some embodiments, upon powering up, the UE (102) may read the USST in the UICC and may check if any of the services related to 5G/6G core network (106) is mentioned in the SIM profile, for example, without limitations, service n° 122 to service n° 135 in an identifier ‘6F38’. If any of the service are available, the UE (102) may decide to start a scanning and registration process with the 5G/6G core (106).

On the other hand, if the UE (102) is unable to read any of the services associated with the 5G/6G core (106), the UE (102) may check for an elementary file containing a list of PLMN. For example, without limitations, if service n° 122 to service n° 135 are not available in the USST in the UICC, the UE (102) may check for the Elementary file “EFPLMNwACT (EF 6F60) mentioned in the Service n° 20 of the USST and check if new generation radio access network (NG-RAN) communication is enabled. If the NG-RAN option is enabled, the UE (102) may start the scanning and registration process with the 5G/6G core (106). On the other hand, if the UE (102) is neither able to read the services nor the NG-RAN communication is enabled, the UE (102) may immediately camp to 4G core network (108) without attempting registration with 5G/6G network (106). In one embodiment, when the UE (102) is neither able to read the services nor the NG-RAN communication is enabled, the UE (102) may deactivate its 5G device capabilities, before camping on to 4G directly. This may avoid the UE (102) trying to latch to 5G network and losing connectivity later.

In some embodiments, the UE (102) may include a 5G SIM and may include device capability of operating in 6G network. In such an embodiment, the UE (102) may follow a similar process as mentioned above for selecting one of 5G or 6G RAT during SIM initialization based on a set of service identifiers and PLMN list as may be described for the 6G network.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

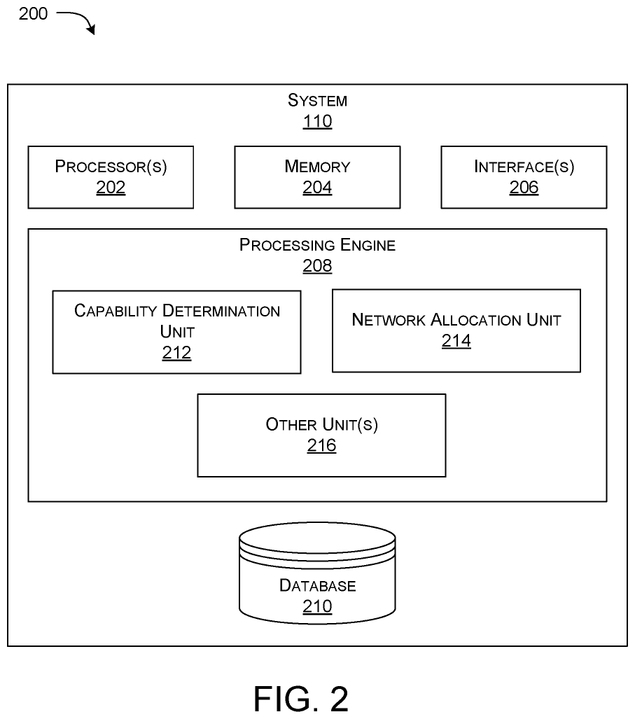

FIG. 2 illustrates an exemplary block diagram (200) of the proposed system for selecting a RAT during SIM initialization, in accordance with an embodiment of the present disclosure.

Referring to FIG. 2, the system (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as Random-Access Memory (RAM), or non-volatile memory such as Electrically Erasable Programmable Read-only Memory (EPROM), flash memory, and the like.

In an embodiment, the system (110) may include an interface(s) (206). The interface(s) (206) may comprise a variety of interfaces, for example, interfaces for data input and output devices, referred to as input/output (I/O) devices, storage devices, and the like. The interface(s) (206) may facilitate communication for the system (110). The interface(s) (206) may also provide a communication pathway for one or more components of the system (110). Examples of such components include, but are not limited to, processing unit/module(s) (208) and a database (210).

The processing unit/module(s) (208) may be implemented as a combination of hardware and programming (for example, programmable instructions) to implement one or more functionalities of the processing module(s) (208). In examples described herein, such combinations of hardware and programming may be implemented in several different ways. For example, the programming for the processing module(s) (208) may be processor-executable instructions stored on a non-transitory machine-readable storage medium and the hardware for the processing unit(s) (208) may comprise a processing resource (for example, one or more processors), to execute such instructions. In the present examples, the machine-readable storage medium may store instructions that, when executed by the processing resource, implement the processing unit(s) (208). In such examples, the system (110) may include the machine-readable storage medium storing the instructions and the processing resource to execute the instructions, or the machine-readable storage medium may be separate but accessible to the system (208) and the processing resource. In other examples, the processing unit(s) (208) may be implemented by electronic circuitry. In an aspect, the database (210) may comprise data that may be either stored or generated as a result of functionalities implemented by any of the components of the processor (202) or the processing units (208).

In an embodiment, the processing unit (208) may include one or more units/modules such as, but not limited to, a capability determination unit (212), a network allocation unit (214), and other unit(s) (216). It may be appreciated that the capability determination unit (212) and the network allocation unit (214) may be similar to the respective capability determination unit (112) and the network allocation unit (114) of FIG. 1.

Referring to FIG. 2, the database (210) may store data related to a user subscription information or SIM profile such as, without limitation, a subscription to 5G/6G services. The subscription to 5G/6G may be determined based on service information and a PLMN list discussed in detail below with reference to FIGS. 4A-4C.

By way of example but not limitation, the one or more processor(s) (202) may read a profile information stored in the database (210) and may assist the capability determination unit (212) to determine if a UE (102) can register with a 5G/6G core (106) of FIG. 1. In some embodiments, the capability determination unit (212), upon determining the capability of the UE (102), may communicate the same to the network selection unit (214) to select the corresponding network.

Referring to FIG. 2, the network selection unit (214) may select to register with the 5G/6G network (106) if the UE (102) is subscribed to the 5G/6G services. Otherwise, the network selection unit (214) may select to register with the 4G network (108) if the UE (102) is not subscribed to 5G services, thereby, reducing unwanted network rejects.

A person of ordinary skill in the art will appreciate that the exemplary block diagram (200) may be modular and flexible to accommodate any kind of changes in the system (110).

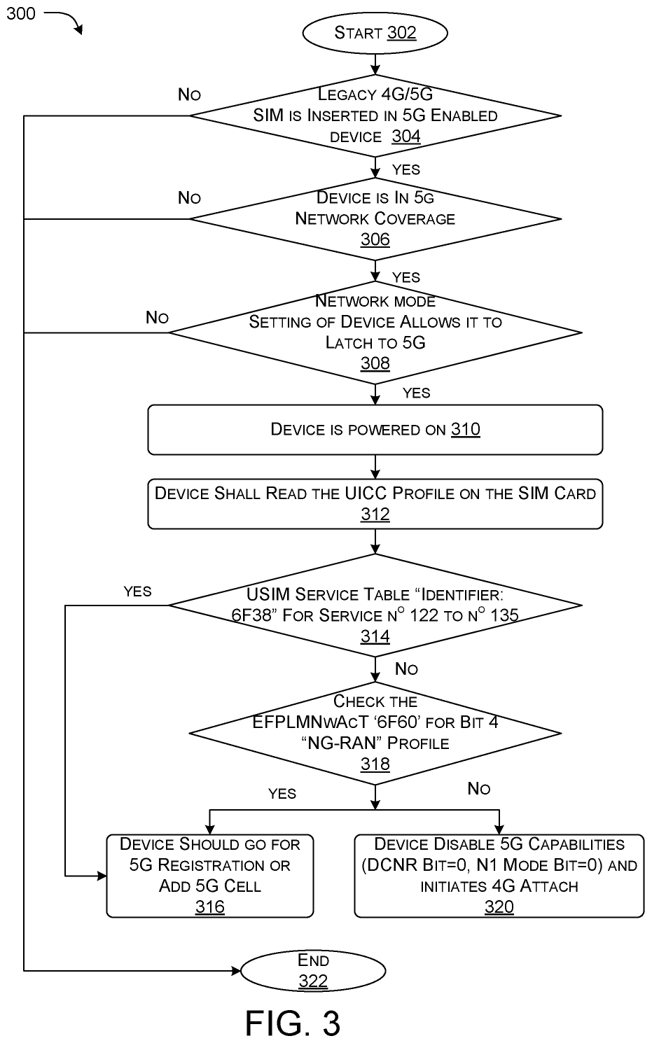

FIG. 3 illustrates an exemplary flow chart of a method (300) for selecting a RAT during SIM initialization, in accordance with an embodiment of the present disclosure.

Referring to FIG. 3, the method (300) may include starting, at step 302, and checking, at step 304, if a legacy 4G/5G SIM is inserted in a 5G enabled user device, for example, UE (102) of FIG. 1. If the legacy 4G/5G SIM is inserted in the 5G enabled user device, the method (300) may include, at step 306, determining if the UE (102) is in 5G network coverage. If the UE (102) is in 5G network converage area, the method (300) may include, at step 308, determining if the network mode settings in the UE (102) allows the UE (102) to latch to the 5G. If the network mode settings allow the UE (102) to latch to 5G network, the method (300) may include, at step 310, powering on the device or UE (102). Further, the method (300) may include, at step 312, reading a UICC profile from the SIM card. The method (300) may include, at step 314, determining if the USIM service table (USST) includes a particular service identifier. If the USST includes the service identifier, for example, without limitations, identifier 6F38 comprising service Nos. 122 to 135, as mentioned below with reference to FIG. 4A, the method (300) may include, at step 316, registering the UE (102) with the 5G/6G core (106) of FIG. 1. On the other hand, if the USST does not include the service identifier, the method (300) may include, at step 318, determining if the elementary file associated with the PLMN specifies whether NG-RAN subscription is enabled. For example, without limitations, the elementary file may include EFPLMNwRAT as described below with reference to FIG. 4B and includes a bitfield for example, bit B4 as described below with reference to FIG. 4C. The “bit b4” when enabled signifies 5G subscription for the SIM. Upon determining the NG-RAN is enabled, the method (300) may include, at step 316, proceeding with registering the UE (102) with the 5G/6G network (106) of FIG. 1. On the other hand, if the NG-RAN access is not enabled, the method (300) may include, at step 320, disabling the 5G capabilities of the UE (102) by setting DCNR bit and NI mode bit to ‘0’ and initiating connection with the 4G network (108) of FIG. 1.

Referring to FIG. 3, the method (300) may include, at step 322, ending the process if the legacy 4G/5G SIM is not inserted and the user device is not 5G enabled, or if the UE (102) is not in the network coverage area, or if the network mode settings in the UE (102) do not allow the UE (102) to latch to the 5G.

FIG. 4A illustrates a universal subscriber identity module (USIM) table (USST) with service identifiers, in accordance with an embodiment of the present disclosure.

Referring to FIG. 4, the USST may include one or more services described for 5G network and a UE (102) subscribed for 5G network may include any of the following services specified in the USST and may be stored in the UICC. For example, document file (DF_{5GS}) may be present at the ADF_{USIM} level if any of the following services are “available” in EF_{UST} (USIM Service Table), for example, Service n° 122 to Service n° 135. The Service n° 122 to Service n° 135 may be defined as follows.
1. Service n° 122 5GS Mobility Management Information
2. Service n° 123 5G Security Parameters
3. Service n° 124 Subscription identifier privacy support
4. Service n° 125 Subscriber Concealed Identifier (SUCI) calculation by the USIM
5. Service n° 126 User account control (UAC) Access Identities support
6. Service n° 127 Control plane-based steering of UE in visiting PLMN (VPLMN)
7. Service n° 128 Call control on packet data unit (PDU) Session by USIM
8. Service n° 129 5GS Operator PLMN List
9. Service n° 130 Support for Subscription Permanent Identifier (SUPI) of type Network Specific Identifier (NSI) or global line identifier (GLI) or global cable identifier (GCI)
10. Service n° 131 3GPP PS Data Off separate Home and Roaming lists
11. Service n° 132 Support for UE route selection policy (URSP) by USIM
12. Service n° 133 5G Security Parameters extended
13. Service n° 134 multi-device (MuD) and multi-identity (MiD) configuration data
14. Service n° 135 Support for Trusted non-3GPP access networks by USIM

FIG. 4B illustrates an elementary file associated with public land mobile network (EFPLMN), in accordance with an embodiment of the present disclosure.

Referring to FIG. 4B, the file EFPLMNwACT (User controlled PLMN selector with Access Technology) may be present if the service n° 20 is available in the USST mentioned above in FIG. 4A. This EF file contains the coding for n PLMNs, where n is at least eight. This information is determined by the user and defines the preferred PLMNs of the user in priority order. The first record indicates the highest priority, and the nth record indicates the lowest. The EF also contains the Access Technologies for each PLMN in this list. The EF provides information as to whether the UE (102) has subscriptions to NG-RAN based on enabling a bit field in a byte format as discussed below with reference to FIG. 4C.

FIG. 4C illustrates a byte format associated with the EFPLMN, in accordance with an embodiment of the present disclosure.

Referring to FIG. 4C, a byte format, for example, byte 5n-1 is shown. The byte format includes fields B1 to B8, wherein the bits B1-B3 signify RFU, the bit B4 signifies whether the new generation radio access network (NG-RAN) is active or not, bits B5-B7 specify an operating mode of the evolved universal mobile telecommunication system terrestrial radio access network (E-UTRAN), and bit B8 signify selection of UTRAN. Referring to FIG. 4C, if the UE (102) is registered with the NG-RAN the B4 will be set to ‘1’. For example, without limitations, when the UE (102) reads the EF6F60 and finds the bit B4 set to 1, the UE (102) of FIG. 1 will start scanning and registering with the 5G/6G core (106) of FIG. 1.

On the other hand, if B4=0, the UE (102) determines that the NG-RAN services are disabled and UE (102) of FIG. 1 may disable the NI mode (standalone (SA) mode) and DCNR (non-standalone (NSA) Mode) and start scanning and registration with 4G/LTE core (108) of FIG. 1 directly without scanning the 5G bands.

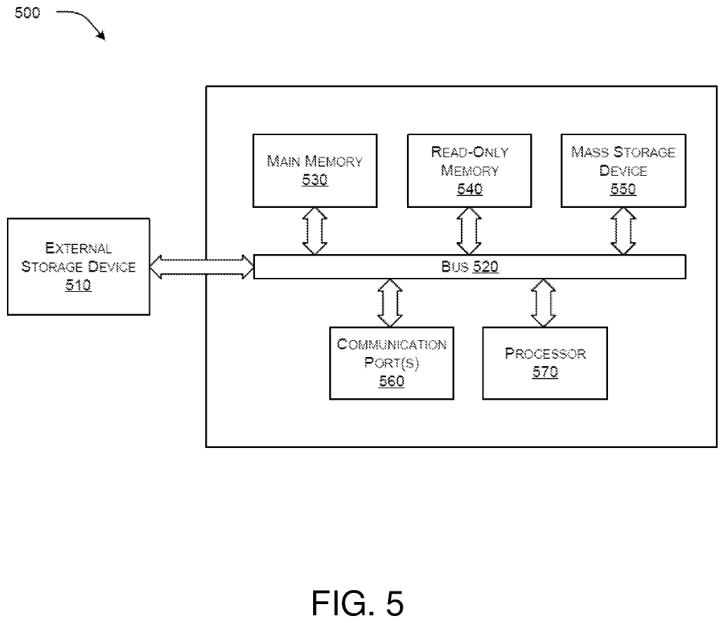

FIG. 5 illustrates an exemplary computer system (500) in which or with which embodiments of the present disclosure may be utilized. As shown in FIG. 5, the computer system (500) may include an external storage device (510), a bus (520), a main memory (530), a read-only memory (540), a mass storage device (550), communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fibre, a serial port, a parallel port, or other existing or future ports. The communication port(s) (560) may be chosen depending on a network, such a Local Area Network (LAN), Wide Area Network (WAN), or any network to which the computer system (500) connects. The main memory (530) may be random access memory (RAM), or any other dynamic storage device commonly known in the art. The read-only memory (540) may be any static storage device(s) including, but not limited to, a Programmable Read Only Memory (PROM) chips for storing static information e.g., start-up or basic input/output system (BIOS) instructions for the processor (570). The mass storage device (550) may be any current or future mass storage solution, which may be used to store information and/or instructions.

The bus (520) communicatively couples the processor (570) with the other memory, storage, and communication blocks. The bus (520) can be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (570) to the computer system (500).

Optionally, operator and administrative interfaces, e.g., a display, keyboard, and a cursor control device, may also be coupled to the bus (520) to support direct operator interaction with the computer system (500). Other operator and administrative interfaces may be provided through network connections connected through the communication port(s) (560). In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### ADVANTAGES OF THE PRESENT DISCLOSURE

The present disclosure provides radio access technology (RAT) selection during subscriber identifier module (SIM) initialization to reduce overhead signalling resulting from attempting fifth generation (5G)/sixth generation (6G) registrations.

The present disclosure provides improved network key performance indicators (KPIs) by reducing signalling overhead.

The present disclosure improves battery efficiency of a user equipment (UE) by reducing unnecessary signalling.

The present disclosure enables the UE to quickly connect to the network without facing any rejection from the network.

We claim:

1. A system (110) for selecting a radio access technology (RAT) during an initialization of a subscriber identity module (SIM) in a user equipment (UE) (102), said system (110) comprising:
one or more processors (202); and
a memory (204) operatively coupled to the one or more processors (202), wherein the memory (204) comprises processor-executable instructions, which on execution, cause the one or more processors (202) to:
read capability information associated with the UE (102) from a universal integrated circuit card (UICC) during the initialization of the SIM;
determine whether the UE (102) includes a capability to connect to a first network (106) having a first RAT based on the capability information; and
register the UE (102) with the first network (106) having the first RAT based on the UE (102) including the capability to connect to the first network (106).

2. The system (110) as claimed in claim 1, wherein the memory (204) comprises processor-executable instructions, which on execution, cause the one or more processors (202) to:
register the UE (102) with a second network (108) having a second RAT based on the UE (102) not being capable to connect to the first network (106).

3. The system (110) as claimed in claim 2, wherein the memory (204) comprises processor-executable instructions, which on execution, cause the one or more processors (202) to:
deactivate one or more device capabilities associated with the UE (102) to connect to the first network (106); and
register the UE (102) with the second network (108).

4. The system (110) as claimed in claim 1, wherein the capability information comprises at least one of: service capability information associated with the UE (102) or a pre-defined public land mobile network (PLMN) list.

5. The system (110) as claimed in claim 4, wherein the service capability information comprises one or more service subscriptions associated with the first network (106).

6. The system as claimed in claim 5, wherein the memory (204) comprises processor-executable instructions, which on execution, cause the one or more processors (202) to:
determine whether a service identifier associated with the one or more service subscriptions in the first network (106) is present in the service capability information; and
register with the first network (106) based on the presence of the service identifier in the service capability information.

7. The system (110) as claimed in claim 4, wherein the pre-defined PLMN list comprises one or more PLMNs, a RAT associated with the one or more PLMNs, a priority associated with the one or more PLMNs, and a subscription information associated with the one or more PLMNs.

8. The system as claimed in claim 4, wherein the memory (204) comprises processor-executable instructions, which on execution, cause the one or more processors (202) to:
determine whether a subscription to the first network (106) is enabled based on the subscription information in the PLMN list; and
register with the first network (106) based on the subscription to the first network (106) being enabled in the subscription information.

9. A method for selecting a radio access technology (RAT) during an initialization of a subscriber identity module (SIM) in a user equipment (UE) (102), the method comprising:
reading, by one or more processors (202), capability information associated with the UE (102) from a universal integrated circuit card (UICC) during the initialization of the SIM;
determining, by the one or more processors (202), whether the UE (102) includes a capability to connect to a first network (106) having a first RAT based on the capability information; and
registering, by the one or more processors (202), the UE (102) with the first network (106) having the first RAT based on the UE (102) including the capability to connect to the first network (106).

10. The method as claimed in claim 9, comprising:
registering, by the one or more processors (202), the UE (102) with a second network (108) having a second RAT based on the UE (102) not being capable to connect to the first network (106).

11. The method as claimed in claim 10, comprising:
deactivating, by the one or more processors (202), one or more device capabilities associated with the UE (102) to connect to the first network (106); and
registering, by the one or more processors (202), the UE (102) with the second network (108).

12. The method as claimed in claim 9, wherein the capability information comprises at least one of: service capability information associated with the UE (102) or a pre-defined public land mobile network (PLMN) list.

13. The method as claimed in claim 12, wherein the service capability information comprises one or more service subscriptions associated with the first network (106).

14. The method as claimed in claim 13, comprising:
determining, by the one or more processors (202), whether a service identifier associated with the one or more service subscriptions in the first network (106) is present in the service capability information; and
registering, by the one or more processors (202), with the first network (106) based on the presence of the service identifier in the service capability information.

15. The method as claimed in claim 12, wherein the pre-defined PLMN list comprises one or PLMNs, a RAT associated with the one or more PLMNs, and a priority order associated with the one or more PLMNs, and a subscription information associated with the one or more PLMNs.

16. The method as claimed in claim 15, comprising:
determining, by the one or more processors (202), whether a subscription to the first network (106) is enabled based on the subscription information in the PLMN list; and
registering, by the one or more processors (202), with the first network (106) based on the subscription to the first network (106) being enabled in the subscription information.

17. A user equipment (UE) (102), comprising:
a subscriber identity module (SIM) card; and
one or more processors (202) communicatively coupled to a system (110) and operatively coupled to a memory (204) comprising processor-executable instructions, which on execution, cause the one or more processors (202) to:
read capability information associated with the UE (102) from a universal integrated circuit card (UICC) during the initialization of the SIM card;
determine whether the UE (102) includes a capability to connect to a first network (106) having a first radio access technology (RAT) based on the capability information; and
register the UE (102) with the first network (106) having the first RAT based on the UE (102) including the capability to connect to the first network (106).

18. A non-transitory computer readable medium that comprises one or more instructions stored thereupon that when executed by a processor causes the processor to:
read capability information associated with a user equipment (UE) (102) from a universal integrated circuit card (UICC) during an initialization of a subscriber identity module (SIM) card;
determine whether the UE (102) includes a capability to connect to a first network (106) having a first radio access technology (RAT) based on the capability information; and
register the UE (102) with the first network (106) having the first RAT based on the UE (102) including the capability to connect to the first network (106).
